(19) United States
(12) Patent Application Publication
(10) Pub. No.: US 2017/0085284 A1
(43) Pub. Date: Mar. 23, 2017

(54) MOBILE PHONE CASE WITH SELFIE-STICK

(71) Applicant: Chunbing Ai, Shenzhen (CN)

(72) Inventor: Chunbing Ai, Shenzhen (CN)

(21) Appl. No.: 15/004,914

(22) Filed: Jan. 23, 2016

(30) Foreign Application Priority Data
Sep. 23, 2015 (CN) 201520744403.7

(51) Int. Cl. H04B 1/3888; H04M 1/725; H04M 1/02

(52) U.S. Cl. CPC H04B 1/3888; H04M 1/026; H04M 1/72527

(57) ABSTRACT

A mobile phone case is fully integrated with an extendable selfie stick where the selfie stick can be folded and stored in the back of the mobile phone case when not used. The selfie stick can be unfolded and extended for settle photographs when needed. This mobile phone case combines a selfie stick into a protection case. It is multifunctional, portable, and easy-to-use.

### BACKGROUND OF THE INVENTION

The inventions disclosed herein generally relate to mobile phone cases. More specifically, they relates to a mobile phone case integrated with a selfie-stick.

With the selfie photograph turning into a fashion, selfie-stick also becomes much more popular. Selfie-stick, with a long pole attached to mobile or camera, may function as photo taking assisting device. Hand-held selfie portrait may only include few people due to the limitation of one's arm's length. With the help of a selfie-stick, shooting angle and range are much bigger. More people and larger scale of backgrounds can be included into a single photo. Till now the selfie-stick is a separate part and has not been successfully integrated with a cell phone. The selfie-stick is usually carried separately from the phone or camera. Additional storage space is required to store a selfie-stick. In sum, innovative solutions are needed to solve these issues and shortcomings with current designs of selfie-stick for selfie photo shooting.

### SUMMARY

The mobile phone case designs disclosed herein provides a phone case that not only protects the phone from scratches but also fully integrates a selfie-stick. It provides a fully integrated case that is artistically desirable and easy to carry with no additional burden to the user. The highlight for the present invention is that a foldable and extendable settle-stick is integrated into the back of cellphone case. When the selfie function is not used, the selfie-stick can be fully folded and stored in the cellphone case. When the selfie function is used, the selfie stick could be fully extended out of the case.

The integrated selfie-stick includes a rotary rod and an adjustable rod. The rotary rod has an L shaped exterior. One side of the rotary rod is attached to the back of the cellphone case. The other side of the rotary rod is attached to the adjustable rod. A selfie remote control button is located on the adjustable rod. The control button is connected with as selfie control device.

A groove is located at the back of cellphone cover. The groove is designed to store the adjustable rod and the rotary rod.

An installation hole is located at the back of cellphone case. A fist position lock with an axial hole is inserted into said installation hole to hold tight of the selfie stick. A first connection hole that matches said installation hole is located on one side of said rotary rod. The rotary rod is connected to the installation hole via a first bolt knob. The bolt diameter of said first bolt knob matches the size of the hole in the first position lock. The first bolt knob includes thread in the far end of the bolt. Through the first bolt knob, the rotatory rod is connected with said cellphone case through the first position lock into the installation hole. The end of the bolt may also include a screw nut.

A first connection component is located on one side of the rotary rod. A second connection hole is located at the top of the first connection component. The axis of the second connection hole is perpendicular to the axis of the first connection hole. A U shaped second connection component is located at the connection section of adjustable rod. A third connection hole that matches with the second connection hole is located at the second connection component. The second connection component connects the first connection component via a second bolt knob. The bolt diameter of the second bolt knob matches the size of the second connection hole. The second bolt knob crosses through said connection holes of the first and second connection components and is screwed into said second connection hole. The second bolt knob includes thread in the far end of the bolt and may include a screw nut.

The mobile phone case designs disclosed herein include a cellphone case with a main case body and a cellphone back board. The main case body of the cellphone case is designed to cover a cellphone. The selfie-stick connects to the back of the cellphone case. The cellphone back board is detachably attached to the side of the main case body facing a cellphone.

The mobile phone case designs disclosed herein provide a phone case that not only protects the phone from scratches but also fully integrate a selfie-stick. The case designs disclosed herein may provide extra space for storage of the selfie-stick. It is multifunctional, portable, and provides many easy-to-use features.

### BRIEF DESCRIPTION OF THE DRAWINGS

FIG. 1 is an overall design diagram of one preferred embodiment with a folded selfie-stick.

FIG. 2 is an overall design diagram of one preferred embodiment with an integrated selfie-stick in use.

FIG. 3 is a schematic diagram of the various components in a preferred embodiment of the present inventions.

The figures depicts a cellphone case 1, a main case body 11, an installation hole 111, storage groove 112, cellphone back board 12, selfie-stick 2, rotary rod 21, a first connection hole 211, a first connection component 212, a second connection hole 213, adjustable rod 22, selfie control button 221, a second connection component 222, a third connection hole 223, a first bolt knob 23, the bolt portion of the first knob 231, a first position lock 24, the axial hole of the first position lock 241, a second bolt knob 25, the bolt portion of the second knob 251, a cellphone 3.

### DETAILED DESCRIPTION

The following description provides details with reference to the accompanying drawings. It should be understood that the inventions may be embodied in many different forms and should not be construed as limited to the embodiments set forth herein.

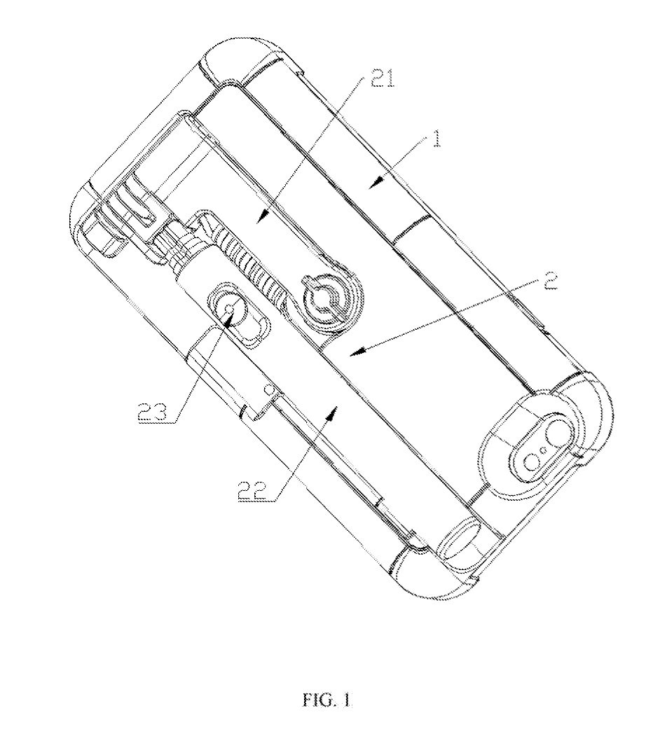

As shown in FIGS. 1 through 3, the mobile phone case disclosed herein includes the main case body 11, the cellphone back board 12 and selfie-stick 2.

As shown in FIGS. 1, 2 and 3, the main case body of cellphone case 11 may cover and protect a cellphone 3. The shape and size of the main case body 11 may be redesigned to fit the different brands and shapes of a cellphone 3. An installation hole 111 is located at the back of the main case body 11. The installation hole 111 functions as the connection point to selfie-stick 2. A storage groove 112 is located in the main cellphone case body 11. The cellphone back board 12 is located inside the main case body 11, facing a cellphone. The shape and size of the cellphone back board 12 matches to the cellphone 3. The side of the cellphone back board 12 facing the cellphone 3 is flat. The other side of the cellphone back board 12 connects with the selfie-stick. The main case body 11 and the cellphone back board 12 are detachably attached with snap posts or screws.

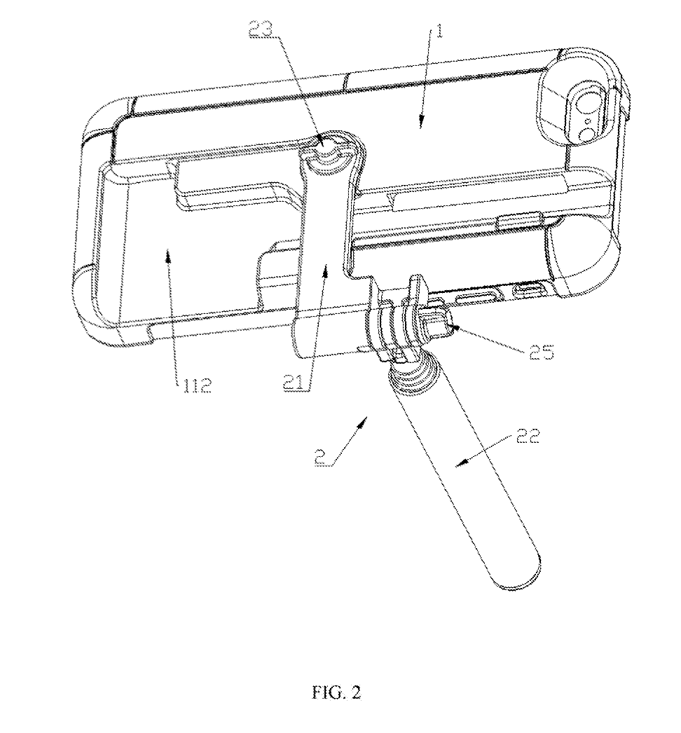

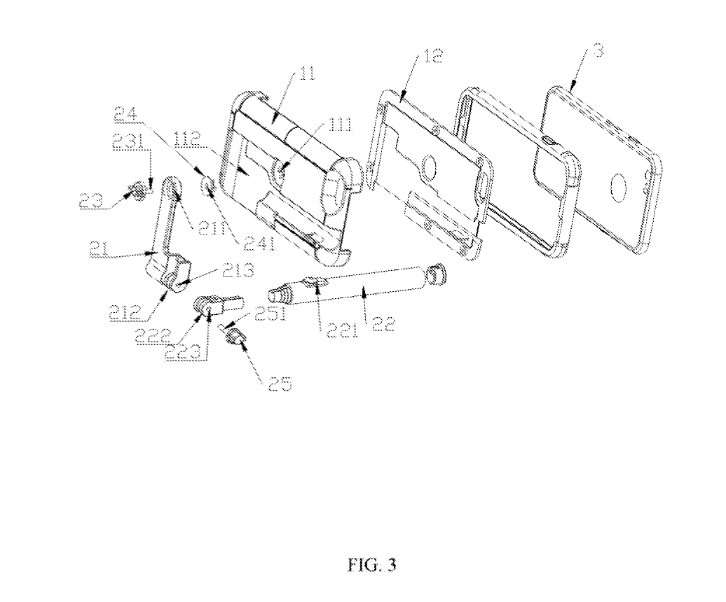

As shown in FIGS. 2 and 3, the selfie-stick 2 connects to the back of the main cellphone case body. The selfie-stick is extendable. When not used, the selfie-stick 2 may fold into the storage groove 112.

As shown in FIG. 3, the integrated selfie-stick 2 contains a rotary rod 21 and an adjustable rod 22. The rotary rod 21 has an L shaped exterior. One side of the rotary rod is attached into the back of the main cellphone case body. The other side of the rotary rod is attached to the adjustable rod 22. This design makes the adjustable and rotary rods easily foldable. To fully integrate the selfie stick into the cellphone case, a first connection hole 211 is located at one side of the rotary rod. The first connection hole is in round shape and matches the installation hole 111 that is located in the main cellphone case body 11. The rotary rod 21 connects to the main case body 11 via a first bolt knob. The bolt portion 231 is located at the center of the first bolt knob 23. The length of the first bolt knob 23 is substantially the same or longer than the sum of the thickness of the rotary rod 21 and the main case body 11, which makes it possible for the bolt knob to pass through the rotary rod 21 and the main case body 11 and reaches to the other side of the main case body 11. The far end of the first bolt knob has external thread and may have a screw nut. A first position lock 24 is inserted inside the installation hole 111 and cannot rotate. A positioning groove is located in the installation hole 111. A positioning component, matching the positioning groove, is located at the first position lock 24. The first position lock 24 is inserted into the positioning groove in the installation hole 111. The first position lock 24 is then fixed to ensure that the rotary rod remains connected with the main case body. The first position lock includes an axial hole 241. The rotary rod 21 connects to the back of the main case body 11. The first connection hole 211 is located on one side of the rotary rod 21 and faces the axial hole 241 in the first position lock 24. The bolt portion 231, which is part of first bolt knob 23, passes through the first connection hole 211 and the axial hole 241 and extends to the other side of the main case body 11. The end of the bolt portion can be screwed into the main case body 11. The rotary rod 21 connects to the back side of the main case body 11.

The other side of the rotary rod 21 connects with the adjustable rod 22. A first connection component 212 is located on the other side of rotary rod 21. The first connection component includes one or more spaced compartments designed hook with the adjustable rod. A second connection hole 213 is located in the first connection component 212. The second connection hole matches the third connection hole in the second connection component, which allows a connection with the adjustable rod 22 through a second bolt knob 25. The axis of the second connection hole 213 is perpendicular to the axis of the first connection hole 211. The selfie-stick 2 can be rotated towards at least three directions, which make it possible to rotate freely to take selfie photos.

The adjustable rod 22 is designed as a hollow stick that includes a selfie control device. A selfie control button 221 is located on the outside of the adjustable rod 22 and connects to the selfie control device. The design of a selfie control device may be found in prior or current known designs. A U shaped second connection component 222 is located at the connection side of the adjustable rod 22. The size and shape of the second connection component 222 matches the first connection component 212. The second connection component 222 can be inserted into the first connection component 212. A third connection hole 223, which matches the size of the second connection hole 213, is located at the second connection component 222. The bolt portion 251 is located at the center of a second bolt knob 25. The length of the bolt portion 251 is substantially the same or longer than the length of the first connection component 212. The far end of the bolt portion 251 has external thread which may be connected to a screw nut. All three sizes, i.e., the diameter of the bolt portion 251, the diameter of the second connection hole 213, and the diameter of the third connection hole 223 matches with each other. The bolt portion 251 passes through the first connection component 212, the connection hole on the second connection component 222, and extends to the second connection hole 213 located in the rotary rod 21. The far end of the bolt portion 251 has thread and may be fixed by a screw nut. The rotary rod 21 and the adjustable rod 22 are therefore connected.

Rotary bolt knobs connects the rotary rod to the main case body 11 and the adjustable rod 22, which make it possible to rotate freely when taking a selfie photo. The storage groove 112 may store selfie-stick when not in use. These new cellphone cases with a foldable selfie-stick may not only protect a cellphone but also make it convenient to take selfie photo.

Although exemplary embodiments of the present inventions have been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims.

1. A case for a mobile phone with a selfie-stick integrated thereof comprising:
a cellphone case;
a detachably extendable selfie-stick, wherein the selfie-stick supports the cellphone from the proximate center of the back of the cellphone case;
wherein said cellphone case further includes a storage groove designed to store said selfie-stick when not in use;
wherein said selfie-stick is integrated into the back of said cellphone case in said storage groove;
a rotary rod;
an adjustable rod;
wherein said rotary rod is L-shaped and one end of said rotary rod is attached to the back of said cellphone case while the other end is attached to said adjustable rod; and
wherein said adjustable rod further includes a selfie control button located on the outside and connected to a selfie control device.

2. (canceled)

3. The mobile phone case of claim 1 wherein said storage groove is located at the back of said cellphone case and designed to store said rotary rod and said adjustable rod when not in use.

4. The mobile phone case of claim 3 further comprises:
an installation hole located at the back of said cellphone case;
a first position lock with an axial hole inserted into said installation hole;
a first connection hole matching said installation hole is located on one side of said rotary rod;
a first bolt knob that connects said rotary rod to said installation hole;
wherein the bolt diameter of said first bolt knob matches the size of the axial hole in said first position lock; and said first bolt knob includes thread in the far end of the bolt; and
wherein said rotatory rod is connected with said cellphone case via said first bolt knob through said first position lock into said installation hole.

5. The mobile phone case of claim 4 wherein the other side of said rotary rod connects with said adjustable rod and further comprising:
a first connection component located on the other side of said rotary rod wherein said first connection component includes a second connection hole and one or more spaced compartments to hook with said adjustable rod;
a second U-shaped connection component that includes a third connection hole comparable to said second connection hole;
wherein the axis of said second connection hole is perpendicular to the axis of said first connection hole;
wherein said second connection component is designed to book with said first connection component through a second bolt knob;
wherein the bolt diameter of said second bolt knob matches the size of said second connection hole;
wherein said second bolt knob crosses through said connection holes of said first and second connection components and is screwed into said second connection hole; and
wherein said second bolt knob includes thread in the far end of the bolt.

6. The mobile phone case of claim 5 wherein said mobile phone case further comprises:
a main case body;
a cellphone back board;
wherein said cellphone back board is detachably attached to the side of said main case body facing a cellphone; and
wherein said main case body is shaped to cover a cell phone and said selfie stick is connected to the back of said main case body.
